(19) United States
(12) Patent Application Publication
(10) Pub. No.: US 2012/0218099 A1
(43) Pub. Date: Aug. 30, 2012

(54) RELAY METHOD FOR ALARM SYSTEM AND ALARM DEVICE

(75) Inventors: Yoshitaka Egawa, Tokyo (JP); Hiroshi Shima, Yokohama-shi (JP)

(73) Assignee: Hochiki Corporation, Shinagawa-ku, Tokyo (JP)

(21) Appl. No.: 13/505,300

(22) PCT Filed: Nov. 1, 2010
(86) PCT No.: PCT/JP2010/069421

§ 371 Date: May 1, 2012

(30) Foreign Application Priority Data
Nov. 5, 2009 (JP) 2009-253805

(51) Int. Cl. G08B 23/00

(52) U.S. Cl. 340/502

(57) ABSTRACT

The relay method for an alarm system of the present invention includes: a third process in which a reception intensity of the acknowledgement signal is measured when the source alarm device receives the acknowledgement signal, and in which, if there are one or more destination alarm devices that have not transmitted the acknowledgement signal among all of the destination alarm devices registered in advance, a destination alarm device that has the lowest reception intensity of the acknowledgement signal is assigned as a relay destination alarm device; and a fourth process in which an abnormality signal is relay-transmitted from the source alarm device, through the relay destination alarm device, to the destination alarm devices that are interconnected with the relay destination alarm device, and then, from the destination alarm device that has received the abnormality signal, a signal indicating that a sender thereof is the destination alarm device is outputted, and also an acknowledgement signal is transmitted to the source alarm device. In addition, when there are one or more all of the destination alarm devices which have not transmitted an acknowledgement signal to the source alarm device among all of the destination the alarm devices registered in advance, the third and fourth processes are repeated.

### TECHNICAL FIELD

The present invention relates to a relay method for an alarm system which detects an abnormality, such as a fire, and gives a warning and also relay-transmits a signal to an alarm device, which is interconnected with the alarm device that has detected the abnormality, so that the warning is interconnection-output, and to an alarm device used in this alarm system.

Priority is claimed on Japanese Patent Application No. 2009-253805, filed Nov. 5, 2009, the content of which is incorporated herein by reference.

### BACKGROUND ART

A conventional residential alarm device (hereinafter, referred to as an “alarm device”) detects an abnormality, such as a fire or a gas leak, in a house and gives a warning. As an alarm system using such an alarm device, an alarm system with a structure in which a plurality of alarm devices operating with battery power communicate with each other by radio is known. Through such a configuration, an alarm device which detects an abnormality becomes an alarm device of an interconnection source, and the abnormality information is transmitted from the alarm device of the interconnection source to alarm devices of interconnection destinations. Accordingly, when one alarm device of the interconnection source detects the abnormality information, warnings are also output from alarm devices of the interconnection destinations (Patent Document 1).

In the alarm system, for example, when a fire is detected by a certain alarm device, this alarm device is recognized as an alarm device of the interconnection source. Then, a voice message “Woo woo. A fire alarm device has been activated. Please check the cause of the activation of the fire alarm device.” is output from the alarm device of the interconnection source as a warning indicating the alarm device of the interconnection source, for example. On the other hand, a voice message “Woo woo. A fire alarm device different from this alarm device has been activated. Please check the cause of the activation of the fire alarm device different from this alarm device.” is output from the alarm device of the interconnection destination of the alarm device of the interconnection source.

A method of distinguishing the alarm device of the interconnection source from the alarm device of the interconnection destination by changing a voice message and a display of an alarm lamp between the alarm device of the interconnection source and the alarm device of an interconnection destination as described above is used. As an example of such a method, a method of changing a display, such as blinking the alarm lamp of the interconnection source and flashing the alarm lamp of the alarm device of the interconnection destination, is used.

### RELATED DOCUMENTS

### Patent Documents

[Patent Document 1] Japanese Unexamined Patent Application, First Publication No. 2007-094719

### SUMMARY OF INVENTION

### Technical Problem

In a wireless alarm system which performs such a conventional interconnected alarm device, there has been a case where not only an alarm device installed in each room in the house but also an alarm device installed at a location distant from an alarm device of the interconnection source, such as an outdoor garage or a separate building, is interconnected. In addition, there have been cases where a communication environment is changed from the original environment when the alarm system was first installed, for example, by redecorating the rooms after installing alarm devices inside and outside the house.

Therefore, even if it could be confirmed that a plurality of alarm devices could communicate with each other when the alarm system was first installed, there was a possibility that some alarm devices could not communicate with each other while operating. In this case, an alarm device which detects an abnormality becomes an alarm device of the interconnection source, and the abnormality information is not transmitted to alarm devices of some interconnection destinations even if the abnormality information is transmitted from the alarm device of the interconnection source to alarm devices of the interconnection destinations. As a result, since alarm devices of some interconnection destinations cannot be interconnected with the alarm device of the interconnection source in order to output a warning, there has been a possibility that the reliability of interconnected monitoring in the alarm system cannot be sufficiently ensured.

In order to solve such a problem, when a signal indicating an abnormality is transmitted from an alarm device of an interconnection source to an alarm device of an interconnection destination, the alarm device of the interconnection destination is used as an alarm device of a relay destination, and the alarm device has a function of relaying a signal to an alarm device interconnected with the alarm device of the relay destination. According to the alarm device including such a function, the signal indicating an abnormality transmitted from the alarm device of the interconnection source is sequentially relayed between alarm devices which form a linkage group. Thus, even an alarm device installed at a location distant from the alarm device of the interconnection source can reliably receive the signal indicating an abnormality. Accordingly, even an alarm device installed at a location distant from the alarm device of the interconnection source can reliably output a warning.

In the case of the method of relaying a signal from the alarm device of the relay destination to the alarm device interconnected with the relay destination, however, the alarm device of the relay destination often receives a relay signal emitted from itself Therefore, since unnecessary communication is repeatedly performed between alarm devices, traffic becomes complicated. In this case, since power consumption related to receiving processing or transmission processing in an alarm device is increased, there has been a problem in that the battery life of the alarm device is shortened. Moreover, since the number of times (number of stages) of relay transmission of a signal is increased, there has also been a problem in that the operation of the alarm system is delayed.

The present invention has been made in view of the above situation, and it is an object of the present invention to provide a relay method for an alarm system capable of improving the reliability of interconnected monitoring by relay transmission and of performing relay transmission in an appropriate range by suppressing the number of times of relay to a minimum and an alarm device used in this alarm system.

### Solution to Problem

The present invention adopts the following means in order to solve the above-described problem and achieve the relevant object.

(1) A relay method for an alarm system includes: a first process in which an alarm device that has detected an abnormality, among a plurality of alarm devices arranged in a monitored area and interconnected with each other, outputs an abnormality warning indicating that a sender thereof is a source alarm device, and in which an abnormality signal is transmitted to all of destination alarm devices interconnected with the source alarm device; a second process in which a destination alarm device that has received the abnormality signal outputs a signal indicating that senders thereof is the destination alarm device, and in which an acknowledgement signal is transmitted to the source alarm device; a third process in which a reception intensity of the acknowledgement signal is measured when the source alarm device receives the acknowledgement signal, and in which, if there are one or more destination alarm devices that have not transmitted the acknowledgement signal among all of destination alarm devices registered in advance, a destination alarm device that has the lowest reception intensity of the acknowledgement signal is assigned as a relay destination alarm device; and a fourth process in which an abnormality signal is relay-transmitted from the source alarm device, through the relay destination alarm device, to destination alarm devices that are interconnected with the relay destination alarm device, and then, from a destination alarm device that has received the abnormality signal, a signal is outputted indicating that a sender thereof is a destination alarm device, and also an acknowledgement signal is transmitted to the source alarm device, wherein when there are one or more destination alarm devices which have not transmitted an acknowledgement signal to the source alarm device among all of destination alarm devices registered in advance, the third and fourth processes are repeated.

(2) In the relay method for an alarm system described in (1), the third and fourth processes may be repeated a predetermined number of times until the source alarm device receives acknowledgement signals from the all of the destination alarm devices registered in advance.

(3) An alarm device includes: a sensor unit that detects a physical phenomenon in a surveyed area and outputs the physical phenomenon; a radio communication unit that transmits and receives a signal by radio to and from a destination alarm device that is a communication target of the radio communication unit; an alarm unit that outputs an abnormality warning; an event detection unit that detects an event including existence or non-existence of an abnormality, through a detection output of the sensor unit; a transmission processing unit that transmits an event signal representing the event to the destination alarm device that is the communication target of the radio communication unit; a receiving processing unit that receives the event signal from the destination alarm device that is the communication target of the radio communication unit; an alarm processing unit that, when the event detection unit detects the abnormality, cause the alarm unit to output an abnormality warning indicating that the alarm device is a source alarm device, and also cause the alarm unit to transmit an event signal indicating an abnormality to the destination alarm device that is the communication target of the radio communication unit, and that, when the destination alarm device receives the event signal indicating an abnormality from the source alarm device, cause the alarm unit to output an abnormality warning indicating that the alarm device is a destination alarm device; an acknowledgement unit that transmits an acknowledgement signal when the destination alarm device receives the event signal from the source alarm device; a retransmission processing unit that, when the acknowledgement signal is received from the destination alarm device, measures a reception intensity and registers the reception intensity together with information regarding the destination alarm device, and that, when there are one or more destination alarm devices which have not transmitted an acknowledgement signal among all of destination alarm devices registered in advance, repeats processing in which the destination alarm devices are designated as a relay destination alarm device in a low-to-high order of the acknowledgement signal reception intensity, and an event signal is transmitted; and a relay processing unit that, when an event signal or an acknowledgement signal designating the alarm device as the relay destination alarm device is received, relay-transmits the received event signal or the received acknowledgement signal to the destination alarm device.

(4) In the alarm described in (3), when the retransmission processing unit repeats a processing in which the destination alarm devices are designated as the relay destination alarm devices and the event signal is transmitted in a low-to-high order of the acknowledgement signal reception intensity, the processing may be repeated for a predetermined number of times, until acknowledgement signals from all of the destination alarm devices registered in advance are received.

### Advantageous Effects of Invention

According to the relay method of the alarm system related to the above-described aspect of the present invention, in the first and second processes, acknowledgement signals are transmitted to the alarm device of the interconnection source from alarm devices of the interconnection destinations when the abnormality signal is transmitted from the alarm device of the interconnection source, which has detected an abnormality, such as a fire, to the alarm devices of all interconnection destinations interconnected with the alarm device of the interconnection source. As a result, it is possible to check all alarm devices interconnected with the alarm device of the interconnection source. Thus, it is possible to check whether or not the alarm devices of all the interconnection destinations registered in advance are interconnected with the alarm device of the interconnection source.

Moreover, in the third process, the reception intensity of each acknowledgement signal is measured by the alarm device of the interconnection source, so that the distance from each alarm device of the interconnection destination to the alarm device of the interconnection source can be checked. Accordingly, when there is an alarm device which is not interconnected with the alarm device of the interconnection source, an alarm device with the lowest reception intensity of the acknowledgement signal can be estimated to have a highest possibility that it will interconnect with an alarm device which is not directly interconnected with the alarm device of the interconnection source. Therefore, an abnormality signal can be transmitted with a high probability to the alarm device which is not interconnected with the alarm device of the interconnection source by designating the alarm device with the lowest reception intensity of the acknowledgement signal as a relay destination at the time of transmission of an abnormality signal.

Moreover, in the fourth process, an acknowledgement signal is transmitted from the alarm device which has received an abnormality signal to the alarm device of the interconnection source through the relay destination, so that all alarm devices interconnected with the alarm device of the interconnection source or the alarm device of the relay destination can be checked. As a result, it is possible to check whether or not acknowledgement signals have been transmitted from alarm devices of all the interconnection destinations registered in advance.

Accordingly, by repeating the third and fourth processes when there is an alarm device which is not interconnected with the alarm device of the interconnection source or the alarm device of the relay destination, a signal can be transmitted to an alarm device which is not directly interconnected with the alarm device of the interconnection source without signal retransmission between alarm devices between which relay was done once. Therefore, the number of times (number of stages) of relay transmission exchanged between alarm devices can be suppressed to a minimum. In addition, since traffic congestion between alarm devices can be suppressed, power consumption related to receiving processing or transmission processing can be suppressed. As a result, shortening of the battery life of an alarm device can be prevented. In addition, since the number of times (number of stages) of relay transmission can be suppressed to a minimum, it is possible to shorten the time until all alarm devices give warnings.

In addition, by repeating the third and fourth processes a predetermined number of times until acknowledgement signals from the alarm devices of all the interconnection destinations registered in advance are transmitted to the alarm device of the interconnection source, it is possible to make all the alarm devices give warnings with a minimum number of relay transmissions.

According to the alarm device related to the above-described aspect of the present invention, since the radio communication unit and the transmission processing unit are provided, an event signal detected by the sensor unit and the event detection unit can be transmitted to an alarm device of its interconnection destination. In addition, since the receiving processing unit, the alarm unit, and the alarm processing unit are provided, an abnormality warning indicating the interconnection destination can be output from the alarm unit when the receiving processing unit receives an event signal from the alarm device of its interconnection destination. In addition, since the acknowledgement unit that transmits an acknowledgement signal is provided, it is possible to check all alarm devices interconnected with the alarm device of the interconnection source. In addition, since the retransmission processing unit designates the alarm device of the interconnection destination as an alarm device of the relay destination in order of the acknowledgement signal with low reception intensity, a signal can be transmitted to an alarm device which is not directly interconnected with the alarm device of the interconnection source without signal retransmission between alarm devices between which relay was done once. Therefore, the number of times (number of stages) of relay transmission exchanged between alarm devices can be suppressed to a minimum. In addition, since traffic congestion between alarm devices can be suppressed, power consumption related to receiving processing or transmission processing can be suppressed. Accordingly, shortening of the battery life of an alarm device can be prevented.

In addition, since the retransmission processing unit repeats the processing of transmitting an abnormality signal a predetermined number of times until acknowledgement signals from the alarm devices of all the interconnection destinations registered in advance are received, it is possible to make all the alarm devices give warnings with a minimum number of relay transmissions.

### BRIEF DESCRIPTION OF DRAWINGS

FIG. 1A is an explanatory view showing transmission processing at the time of abnormality detection in an alarm system related to an embodiment of the present invention.

FIG. 1B is an explanatory view of retransmission processing including relay transmission performed in this alarm system.

FIG. 2 is a block diagram of an alarm device related to the embodiment.

FIG. 3 is an explanatory view of transmission management table used in the present embodiment.

FIG. 4A is an explanatory view of the format of an event signal used in the present embodiment.

FIG. 4B is an explanatory view of the format of a relay event signal used in the present embodiment.

FIG. 5 is a time chart showing event transmission and reception processing in the present embodiment.

FIG. 6 is a time chart showing the event transmission and reception processing subsequent to FIG. 5.

FIG. 7 is a flow chart showing a basic processing operation in the present embodiment.

FIG. 8 is a flow chart showing details of detected event processing in process S25 of FIG. 7.

FIG. 9 is a flow chart showing details of event transmission processing in processes S33, S36, S40, and S42 of FIG. 8.

FIG. 10 is a flow chart showing details of received event processing in process S27 of FIG. 7.

FIG. 11 is a flow chart showing details of ACK transmitting processing in processes S72, S74, S77, and S80 of FIG. 10.

FIG. 12 is a flow chart showing details of event relay processing in process S82 of FIG. 10.

### DESCRIPTION OF EMBODIMENTS

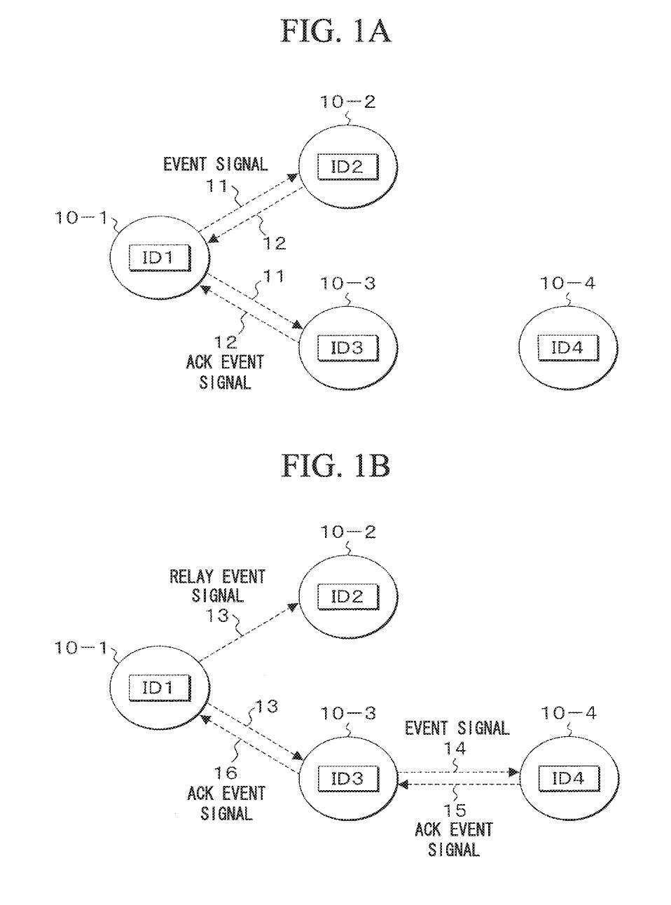

FIG. 1A is an explanatory view showing an alarm system related to an embodiment of the present invention. In FIG. 1A, alarm devices 10-1 to 10-4 are placed in monitored areas, such as a house, for example. Each of the alarm devices 10-1 to 10-4 outputs a warning indicating an interconnection source when an abnormality, such as a fire, is detected. Each of the alarm devices 10-1 to 10-4 transmits to an alarm device of its interconnection destination an event signal indicating the abnormality, such as a fire, so that the alarm device of the interconnection destination outputs a warning indicating that the alarm device is an alarm device of the interconnection destination. In FIG. 1A, transmission source codes of the alarm devices 10-1 to 10-4 are expressed as ID1 to ID4, respectively.

When each of the alarm devices 10-1 to 10-4 receives an event signal (abnormality signal) indicating an abnormality, such as a fire, and outputs a warning indicating the interconnection destination, each of the alarm devices 10-1 to 10-4 transmits an ACK (acknowledgement signal) event signal to the alarm device of the interconnection source as an acknowledgement signal.

When transmitting this ACK event signal any one of the alarm devices 10-1 to 10-4 which becomes an interconnection source measures the reception intensity of the ACK event signal and registers it together with a transmission source code indicating the interconnection destination. If no ACK event signal is acquired from all interconnection destinations registered in advance at the time of registration of this transmission source code, an alarm device of the interconnection destination is designated as a relay destination in order of an ACK event signal with low reception intensity. Then, the ACK event signal is transmitted to an alarm device which is not directly interconnected with the alarm device of the interconnection source by repeating retransmission processing for transmitting an event signal indicating an abnormality, such as a fire, from the alarm device of the interconnection source to an alarm device interconnected with the alarm device of the relay destination. This ACK event signal retransmission processing is performed until it reaches a predetermined number of times of retransmission.

Next, a relay method for an alarm system when the alarm device 10-1 detects an abnormality, such as a fire, will be specifically described using FIG. 1A. A relay method for an alarm system includes a first process of transmitting an abnormality signal to all alarm devices interconnected with an alarm device of an interconnection source, a second process of transmitting an acknowledgement signal to the alarm device of the interconnection source, a third process of designating an alarm device with the lowest reception intensity of the acknowledgement signal as a relay destination, and a fourth process of transmitting an acknowledgement signal from the alarm device, which has received the abnormality signal, to the alarm device of the interconnection source.

First, the first process will be described. First, the alarm device 10-1 which has detected an abnormality, such as a fire, outputs a warning indicating an interconnection source while transmitting an event signal 11 indicating the abnormality. Here, the event signal 11 transmitted from the alarm device 10-1 is received by the alarm devices 10-2 and 10-3 interconnected with the alarm device 10-1 of the interconnection source. On the other hand, since the alarm device 10-4 is not directly interconnected with the alarm device 10-1, the event signal 11 transmitted from the alarm device 10-1 is not received by the alarm device 10-4.

Next, the second process will be described. Each of the alarm devices 10-2 and 10-3 which have received the event signal 11 transmitted from the alarm device 10-1 outputs a warning indicating the interconnection destination. In this case, each of the alarm devices 10-2 and 10-3 transmits an ACK event signal 12 (acknowledgement signal) to the alarm device 10-1 of the interconnection source after a predetermined waiting time set at random for each of the alarm devices 10-2 and 10-3 elapses.

In this case, a predetermined ACK receiving time (time for which an acknowledgement signal can be received) is set in advance in the alarm device 10-1 of the interconnection source. In addition, the alarm devices 10-2 to 10-4 are registered in advance as alarm devices of interconnection destinations.

Next, the third process will be described. After receiving the ACK event signal 12 during the ACK receiving time, the alarm device 10-1 measures the reception intensity of the ACK event signal 12 and registers it in a memory together with a transmission source code indicating the interconnection destination. In this case, since the ACK event signal is not received by the alarm device 10-4 among the alarm devices of the interconnection destinations, it is determined that the event signal has not reached the alarm device 10-4.

By this determination, an alarm device near the alarm device 10-4 is designated as a relay destination and a relay event signal from the alarm device 10-1 is retransmitted, as shown in FIG. 1B.

In this case, an alarm device with the lowest reception intensity of the alarm devices 10-2 and 10-3, which are registered in a memory as alarm devices of interconnection destinations of the alarm device 10-1, is selected through the designation of an alarm device of a relay destination. Here, for example, the alarm device 10-3 is selected as a relay destination, and a relay event signal 13 is retransmitted to the alarm device 10-3.

The alarm device 10-3 with the lowest reception intensity can be regarded as an alarm device located farthest from the alarm device 10-1 of the interconnection source, among alarm devices which have received the event signal 11 transmitted first. By designating as a relay destination the alarm device 10-3 which can receive a signal from the alarm device 10-1 of the interconnection source and which is located farthest from the alarm device 10-1 of the interconnection source, the alarm device 10-4, which could not receive a signal from the alarm device 10-1 of the interconnection source, can receive the event signal 13.

Next, the fourth process will be described. First, the relay event signal 13 is retransmitted from the alarm device 10-1 of the interconnection source. In this case, since the relay event signal 13 includes a transmission source code of the alarm device 10-3 as a relay destination, the relay event signal 13 is neglected in the alarm device 10-2 with a different transmission source code, and the alarm device 10-3 which matches the transmission source code operates as a relay destination. Therefore, the relay event signal 13 is converted into a normal event signal 14 in the alarm device 10-3 of the relay destination and is also relay-transmitted to the alarm device 10-4.

After the alarm device 10-4 receives the event signal 14, the alarm device 10-4 outputs a warning indicating the interconnection destination and also transmits an ACK event signal 15 to the alarm device 10-3 of the relay destination.

The alarm device 10-3 of the relay destination receives the ACK event signal 15 from the alarm device 10-4 and relay-transmits the ACK event signal 15 to the alarm device 10-1 of the interconnection source as an ACK event signal 16. In this case, a predetermined ACK receiving time at the time of retransmission of the relay event signal 12 is set in advance in the alarm device 10-1 of the interconnection source. Accordingly, after receiving the ACK event signal 16 during the ACK receiving time, the alarm device 10-1 measures the reception intensity of the ACK event signal 16 and registered it in a memory together with a transmission source code indicating the interconnection destination.

Through the above, the alarm device 10-1 of an interconnection source receives ACK event signals from the alarm devices 10-2 to 10-4 of all interconnection destinations registered in advance. Then, after checking that the ACK event signals from the alarm devices 10-2 to 10-4 of all interconnection destinations registered in advance have been transmitted to the alarm device 10-1 of the interconnection source, the transmission processing including relay retransmission of an event signal is normally terminated. In this case, if there are one or more alarm devices which have not transmitted an acknowledgement signal to the alarm device 10-1 of the interconnection source among the alarm devices 10-2 to 10-4 of all interconnection destinations registered in advance, the alarm device 10-1 of the interconnection source repeats the third and fourth processes. In this case, it is preferable to repeat the third and fourth processes a predetermined number of times until the acknowledgement signals from the alarm devices of all interconnection destinations registered in advance are transmitted to the alarm device 10-1 of the interconnection source.

According to the relay method of the alarm system of the present invention, in the first and second processes, acknowledgement signals are transmitted to the alarm device 10-1 of the interconnection source from an alarm device of the interconnection destination, which has received an abnormality signal, when the abnormality signal is transmitted from the alarm device 10-1 of the interconnection source to the alarm devices 10-2 to 10-4 of all interconnection destinations interconnected with the alarm device 10-1 of the interconnection source. Accordingly, it is possible to check all alarm devices interconnected with the alarm device 10-1 of the interconnection source. Thus, it is possible to check whether or not the alarm devices 10-2 to 10-4 of all interconnection destinations registered in advance are interconnected with the alarm device 10-1 of the interconnection source.

Moreover, in the third process, the reception intensity of each acknowledgement signal is measured by the alarm device 10-1 of the interconnection source, so that the distance from each of the alarm devices 10-2 to 10-4 of the interconnection destinations to the alarm device 10-1 of the interconnection source can be checked. Accordingly, when there is an alarm device which is not interconnected with the alarm device 10-1 of the interconnection source, the alarm device 10-3 with the lowest reception intensity of the acknowledgement signal can be estimated to have a highest possibility that it will interconnect with the alarm device 10-4 which is not directly interconnected with the alarm device 10-1 of the interconnection source. Therefore, an abnormality signal can be transmitted with a high probability to the alarm device 10-4 which is not interconnected with the alarm device 10-1 of the interconnection source by designating the alarm device 10-3 with the lowest reception intensity of the acknowledgement signal as a relay destination at the time of transmission of an abnormality signal.

Moreover, in the fourth process, an acknowledgement signal is transmitted from the alarm device 10-3 which has received an abnormality signal to the alarm device 10-1 of the interconnection source through the relay destination, so that all alarm devices interconnected with the alarm device 10-1 of the interconnection source or the alarm device 10-3 of the relay destination can be checked. Therefore, it is possible to check whether or not acknowledgement signals have been transmitted from the alarm devices 10-2 to 10-4 of all interconnection destinations registered in advance.

Accordingly, by repeating the third and fourth processes when there is an alarm device which is not interconnected with the alarm device 10-1 of the interconnection source or the alarm device 10-3 of the relay destination, a signal can be transmitted to an alarm device which is not directly interconnected with the alarm device 10-1 of the interconnection source without signal retransmission between alarm devices between which relay was done once. Thus, the number of times (number of stages) of relay transmission exchanged between alarm devices can be suppressed to a minimum. Therefore, since traffic congestion between alarm devices can be suppressed, power consumption related to receiving processing or transmission processing can be suppressed. As a result, shortening of the battery life of an alarm device can be prevented. In addition, since the number of times (number of stages) of relay transmission can be suppressed to a minimum, it is possible to shorten the time until all alarm devices give warnings.

In addition, by repeating the third and fourth processes a predetermined number of times until acknowledgement signals from the alarm devices 10-2 to 10-4 of all interconnection destinations registered in advance are transmitted to the alarm device 10-1 of the interconnection source, it is possible to make all the alarm devices give warnings with a minimum number of relay transmissions.

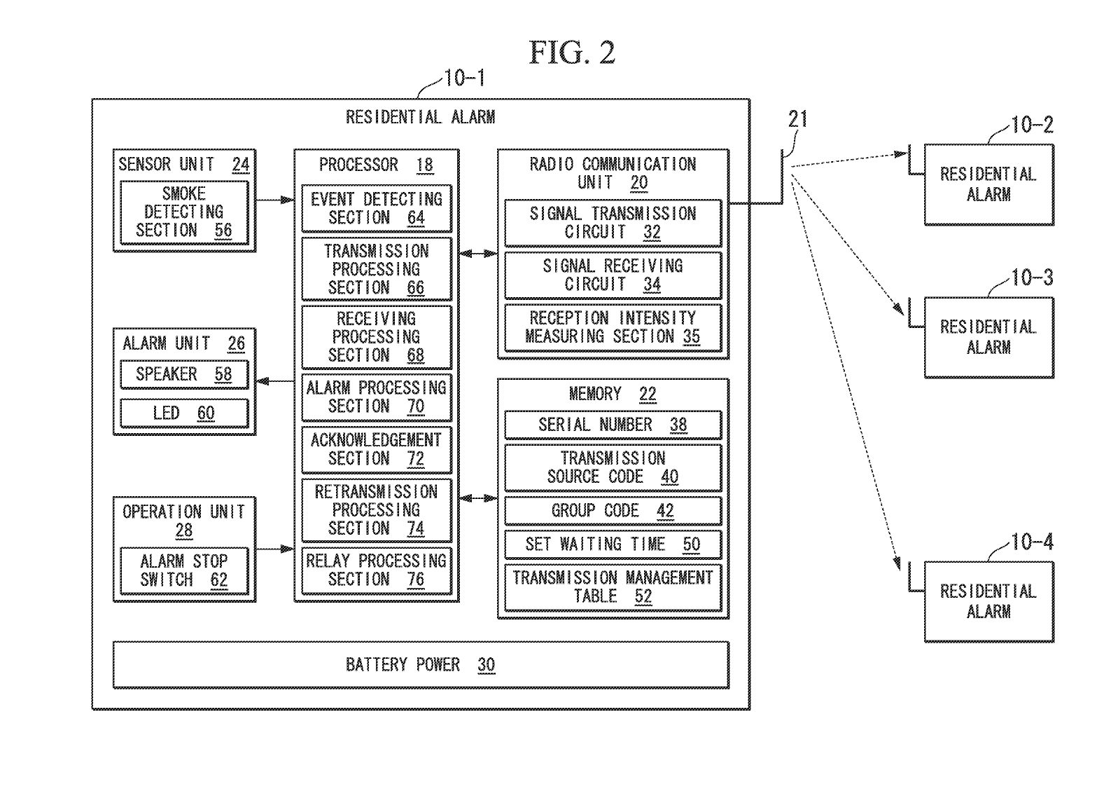

Next, the circuit configuration of the alarm device 10-1 provided in the alarm system shown in FIGS. 1A and 1B will be described in detail using FIG. 2. In addition, since the alarm devices 10-2 to 10-4 of the interconnection destinations have the same configuration as the alarm device 10-1 interconnected therewith, explanation regarding their circuit configurations will be omitted.

The alarm device 10-1 is approximately configured to include a processor 18, a radio communication unit 20, a memory 22, a sensor unit 24, an alarm unit 26, an operation unit 28, and a battery power 30. Hereinafter, details of each component will be described.

The radio communication unit 20 includes an antenna 21, and has a function of transmitting and receiving a signal by radio to and from the alarm devices 10-2 to 10-4 of the interconnection destinations.

A signal transmission circuit 32, a signal receiving circuit 34, and a reception intensity measuring section 35 are provided in the radio communication unit 20. In the radio communication unit 20, for example, a channel frequency f1 is set as one of four channel frequencies (communication frequencies) f1, f2, f3, and f4 of a 400 MHz band. Through such a configuration, an instruction is transmitted from the processor 18 to the radio communication unit 20 and accordingly, event signals are transmitted and received by radio between the alarm device 10-1 and the alarm devices 10-2 to 10-4 of the interconnection destinations.

In the case of Japan, the radio communication unit 20 has a configuration based on STD-30 (radio station and radio equipment standards for a low power security system) or STD-T67 (radio equipment standards for a telemeter, telecontrol, and data transmission of a specific low power radio station) known as standards of a specific low power radio station in a 400 MHz band, for example.

Undoubtedly, the radio communication unit 20 has a configuration based on standards of the allocated radio station of an area if it is installed in an area other than Japan.

The reception intensity measuring section 35 receives an electric wave of an event signal transmitted from each of the alarm devices 10-2 to 10-4 of the interconnection destinations and measures the reception intensity, that is, the carrier intensity. In this case, a reception intensity signal Ri with a DC level corresponding to the reception intensity of the event signal is output. The reception intensity signal Ri with the DC level output from the reception intensity measuring section 35 is read into the processor 18 after AD conversion.

A serial number 38, a transmission source code 40, a group code 42, a set waiting time 50, and a transmission management table 52 are stored in the memory 22.

The serial number 38 is made up of consecutive numbers indicating the order of an event signal in communication between alarm devices, and is for managing relay processing of an event signal. Since the serial number 38 is not directly related to the present embodiment, detailed explanation thereof will be omitted.

The transmission source code 40 is a code (identifier) which specifies an alarm device, and is for estimating the number of alarm devices provided indoors. As such a code, for example, a 26-bit code is used such that the same code is not repeated. As the transmission source code 40, for example, a unique serial number or the like is used. In addition, also for a relay signal transmitted from a repeater 12, a serial number of the repeater or the like is added as a transmission source code.

The group code 42 is a code for forming an interconnected group, and is set common to a plurality of alarm devices. When event signals from the alarm devices 10-2 to 10-4 of the interconnection destinations are received through the radio communication unit 20, the event signals from the alarm devices 10-2 to 10-4 are received as effective signals if group codes included in the event signals from the alarm devices 10-2 to 10-4 match the group code 42 registered in the memory 22 of the alarm device 10-1. Therefore it is possible to avoid interference with an alarm device installed in a monitored area, such as a neighboring house.

In addition, the set waiting time 50 and the transmission management table 52 are stored in the memory 22. The set waiting time 52 is a waiting time until an ACK event signal is transmitted after receiving an event signal, and different waiting times are set in advance for the alarm devices 10-1 to 10-4 included in the same group. For example, this waiting time is set at random on the basis of the transmission source code of the alarm device. Thus, collisions due to simultaneous transmission of ACK event signals are avoided by setting different waiting times for the alarm devices 10-1 to 10-4.

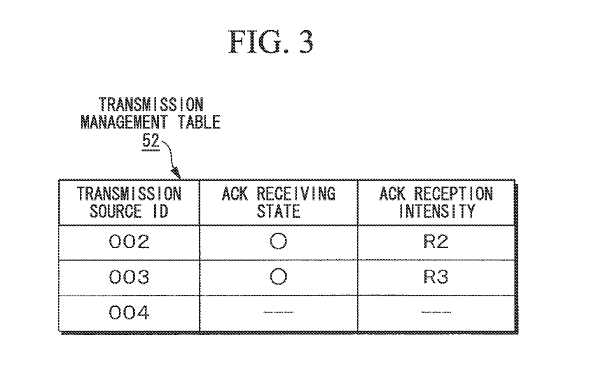

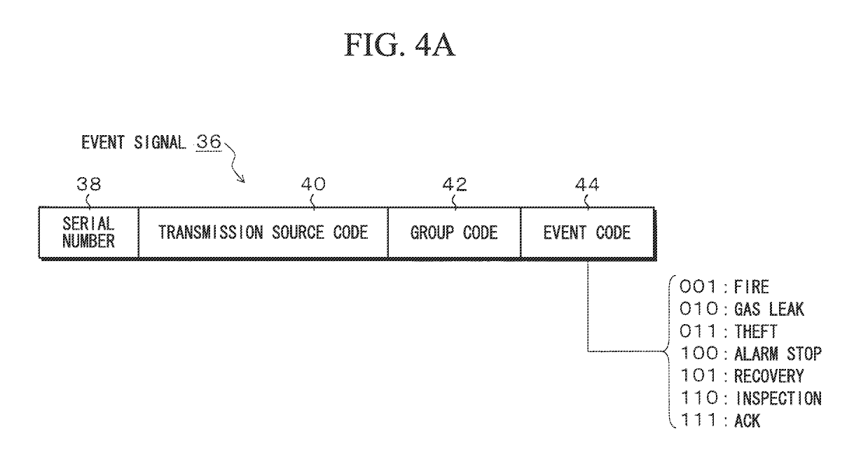

The transmission management table 52 includes a transmission source code, an ACK receiving state, and reception intensity, and “002” to “004” of the alarm devices 10-2 to 10-4 of the interconnection destinations belonging to the same group are registered in advance as transmission source codes, as shown in FIG. 3, for example. As shown in FIG. 1A, an O mark indicating that the ACK event signal 12 has been received from the alarm devices 10-2 and 10-3 of the interconnection destinations and the reception intensities R2 and R3 are registered in the transmission management table 3. In addition, the O mark indicating that the ACK event signal 12 has been received sets a flag bit from 0 to 1 in practice.

The transmission management table 52 is used for determination of a relay destination at the time of retransmission of an ACK event signal. An alarm device which has transmitted an ACK event signal with the lowest reception intensity, among ACK event signals (acknowledgement signals) transmitted from the alarm devices 10-2 to 10-4 registered in a table, is designated as a relay destination of the alarm device 10-1. Then, a first ACK event signal is retransmitted from the alarm device 10-1 through the relay destination. When there is an alarm device which cannot receive an ACK event signal even by the first retransmission, an alarm device which has transmitted an ACK event signal with the second lowest reception intensity is designated as a new relay destination. Then, retransmission of an ACK event signal is performed through the same processes as described above until all alarm devices receive ACK event signals.

The sensor unit 24 has a function of detecting an abnormality, such as a fire, for example. For example, a smoke detecting section 56 is provided in the sensor unit 24, so that the abnormality can be detected when smoke from a fire reaches a predetermined concentration. Instead of the smoke detecting section 56, for example, a temperature detector such as a thermistor which detects the temperature by a fire or various elements which detect changes in other physical phenomena caused by the fire may also be provided as a sensor provided in the sensor unit 24. In addition, a sensor provided in the sensor unit 24 is not limited to one type, and a plurality of elements which detect different phenomena may be combined.

For example, a speaker 58 and an LED 60 are provided in the alarm unit 26. The speaker 58 is provided to output a warning sound, and outputs a voice message or a warning sound from a sound mixing circuit (not shown). A device which outputs a warning sound is not limited to the speaker. For example, a buzzer may be used instead of the speaker 58. The LED 60 is provided to perform alarm display, and displays the occurrence of an abnormality, such as a fire, by flashing, lighting, blinking, or the like. In addition, the LED 60 provided in the alarm unit 26 is not limited to one type, but it is also possible to provide two LEDs with different display colors. By providing two LEDs with different display colors, it is also possible to use different display colors for display of an alarm device of an interconnection source and display of an alarm device of an interconnection destination.

The operation unit 28 has a function of operating an alarm. For example, an alarm stop switch 62 is provided in the operation unit 28. The alarm stop switch 62 can input an alarm stop instruction only when the speaker 58 of the alarm unit 26 performs alarm display using a warning sound.

In addition, the alarm stop switch 62 has a function as an inspection switch which gives an instruction to check the function of an alarm device. For example, when the alarm stop switch 62 is operated at the time of a fire alarm, the alarm is stopped. When the alarm stop switch 62 is operated in a normal state, a function inspection is started and the result is reported.

In addition, when the alarm stop switch 62 is operated in a state where the alarm devices 10-1 to 10-4 output a warning sound, processing of stopping the warning sound is performed. In the present embodiment, one stop processing corresponding to any one of the following (1) to (3) is performed when the alarm stop switch 62 is operated.

(1) When the alarm stop switch 52 of an arbitrary alarm device other than the alarm device 10-1 of the interconnection source among the alarm devices 10-1 to 10-4 is operated, a warning sound is continuously output only from the alarm device 10-1 of the interconnection source and warning sounds from the alarm devices of the interconnection destinations are stopped. On the other hand, when the alarm stop switch 62 of the alarm device 10-1 of the interconnection source is operated, all warning sounds of the alarm device 10-1 of the interconnection source and the alarm devices 10-2 to 10-4 of the interconnection destinations are stopped.

(2) When the arbitrary alarm stop switch 62 of the alarm devices 10-1 to 10-4 while the alarm is operated, all warning sounds are stopped regardless of the alarm device of the interconnection destination and the alarm device of the interconnection source.

(3) The stop processing of (1) is set as a first mode and the stop processing of (2) is set as a second mode, and either one of the modes is selected to perform stop processing.

The battery power 30 is provided to operate the alarm device 10-1. As the battery power 30, for example, a lithium battery or an alkaline battery with a predetermined number of cells is used. As a battery capacity of the battery power 30, for example, the battery life of 10 years is guaranteed by reducing power consumption of all circuit parts including the radio communication unit 20 in the alarm device 10-1.

The processor 18 has a function of executing a program in the alarm device 10-1. In the processor 18, signal transmission and reception to and from the radio communication unit 20, the memory 22, the sensor unit 24, the alarm unit 26, and the operation unit 28 are performed. In order to perform signal transmission and reception between the processor 18 and these units, an event detecting section 64, a transmission processing section 66, a receiving processing section 68, an alarm processing section 70, an acknowledgement section 72, a retransmission processing section 74, and a relay processing section 76 are provided in the processor 18.

The event detecting section 64 has a function of transmitting and receiving a signal to and from the sensor unit 24 and the operation unit 28. Specifically, the event detecting section 64 detects events, such as abnormality detection including a fire, or a recovery instruction to reset the abnormality detection in the sensor unit 24 or events, such as alarm stop or an inspection instruction in the operation unit 28, for example.

The transmission processing section 66 has a function of transmitting an event signal detected by the event detecting section 64 to the alarm device of the interconnection destination. Specifically, for example, when fire detection or a recovery instruction to reset abnormality detection in the sensor unit 24 or an alarm stop or an inspection instruction by the operation unit 28 occurs, the transmission processing section 66 transmits an event signal corresponding to each instruction to the alarm device of the interconnection destination.

The receiving processing section 68 has a function of receiving and decoding the event signals from the alarm devices 10-2 to 10-4 of the interconnection destinations.

The alarm processing section 70 has a function of transmitting by radio the event signal indicating an abnormality, such as a fire, to the alarm device of the interconnection destination. Specifically, for example, when the event detecting section 64 detects an abnormality, such as a fire, as an abnormality in the alarm device 10-1, a warning sound indicating an interconnection source is output from the speaker 58 and the LED 60 is driven to perform display showing the interconnection source.

This example will be described more specifically. First, an abnormality, such as a fire, is sensed by the smoke detecting section 56 provided in the sensor unit 24, and a smoke detection signal is transmitted from the smoke detecting section 56 to the event detecting section 64. Then, an instruction is given from the event detecting section 64 to the alarm processing section 70, so that the voice “Woo woo. A fire alarm device was activated. Please check the cause of the activation of the fire alarm device.” is repeatedly output from the speaker 58 of the alarm unit 26 and the LED 60 is also turned on to perform alarm display showing the interconnection source, for example.

The alarm processing section 70 has a function of performing operations, such as transmission or stop of an alarm device. For example, the alarm processing section 70 transmits an event signal to the antenna 21 through the signal transmission circuit 32 at the time of abnormality detection, such as a fire. The event signal is converted into the channel frequency f1 by transmission of the event signal to the antenna 21, and this converted signal is transmitted from the antenna 21 to the alarm device of its interconnection destination.

On the other hand, when the event signal indicating an abnormality, such as a fire, is transmitted from the alarm device of its interconnection destination at the channel frequency f1, the event signal is received by the signal receiving circuit 34 of the radio communication unit 20. The event signal received by the signal receiving circuit 34 is transmitted to the receiving processing section 68 and the effectiveness is determined When it is determined that the event signal is effective by the receiving processing section 68, an instruction is given from the alarm processing section 70 to the alarm unit 26, so that the voice “Woo woo. A fire alarm device was activated. Please check the cause of the activation of the fire alarm device.” is repeatedly output from the speaker 58 and the LED 60 is also turned on to perform alarm display showing the interconnection source, for example.

When alarm stop operation information is detected from the alarm stop switch 62 provided in the operation unit 28 during the output of an alarm device, this alarm stop operation information is transmitted to the alarm processing section 70. Then, an instruction is given from the alarm processing section 70 to the alarm unit 26, so that the warning sound from the speaker 58 is stopped and the display of the LED 60 is stopped. In this case, the display of the LED 60 does not necessarily need to be stopped immediately, or the display may continue for a predetermined time.

The acknowledgement section 72 has a function of transmitting an ACK event signal for acknowledgement when an event signal is received from the alarm device of the interconnection source.

The retransmission processing section 74 has a function of controlling retransmission of an ACK event signal. Specifically, when the alarm device 10-1 receives an ACK event signal from an alarm device of its own interconnection destination, the reception intensity measuring section 35 measures the reception intensity of the ACK event signal. In this case, the ACK event signal is read into the retransmission processing section 74 after AD conversion of the reception intensity of the ACK event signal, and is registered in the transmission management table 52 shown in FIG. 3 together with a transmission source code indicating that it is a signal fed from the alarm device of the interconnection destination. In this case, when there are one or more alarm devices which have not transmitted an acknowledgement signal among alarm devices of all interconnection destinations registered in advance, the alarm devices of the interconnection destinations are designated as relay destinations in order of an acknowledgement signal with low reception intensity. Then, processing of transmitting a relay event signal is repeated.

The relay processing section 76 has a function of converting a relay event signal, which indicates that the relay processing section 76 has been designated as a relay destination, into a normal event signal not including the designation of a relay destination when the relay event signal is received and relay-transmitting the normal event signal. Moreover, when the relay event signal is relay-transmitted, a predetermined response waiting time of an ACK event signal is set in advance. Accordingly, the relay processing section 76 relay-transmits the ACK event signal as it is if the ACK event signal is received within this response waiting time.

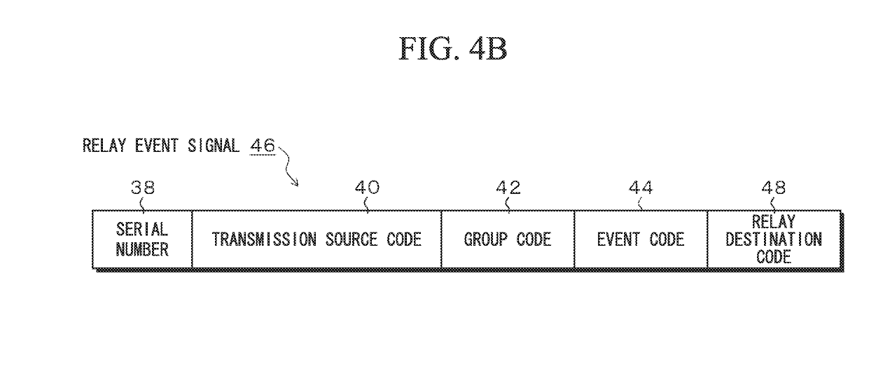

Next, formats of an event signal and a relay event signal 46 will be described using FIGS. 4A and 4B. FIG. 4A is an explanatory view schematically showing the format of an event signal used in the present embodiment. As shown in FIG. 4A, an event signal 36 includes the serial number 38, the transmission source code 40, the group code 42, and an event code 44. Hereinafter, details of each code will be described.

The serial number 38 is made up of consecutive numbers indicating the order of the event signal 36, and increases by 1 whenever the event signal is transmitted. The serial number 38 is for managing relay processing of the event signal 36 in communication between alarm devices, but detailed explanation thereof will be omitted since the function is not directly related to the present embodiment.

The transmission source code 40 is a 26-bit code, for example, and is information indicating an alarm device of the transmission source. The group code 42 is an 8-bit code, for example, and indicates a group to which an alarm device of the transmission source belongs. Specifically, for example, the same group code 42 is given to the alarm devices 10-1 to 10-4 in FIG. 1 since the alarm devices 10-1 to 10-4 form the same group (alarm system). Since this group code 42 is given, recognizing a received signal from an alarm device belonging to another group (which does not need to be interconnected), which is installed in the neighborhood, in the alarm devices 10-1 to 10-4 in this group can be prevented.

Moreover, as a method of recognizing an alarm device for each group, it is not necessary to give the same group code 42 to all of the plurality of alarm devices in the same group. As another specific method, there is a method of giving a common reference code set in advance to alarm devices in a group and giving the unique transmission source code 40 to each alarm device. According to this method, a different group code can be given to each alarm device by the operation between the reference code and the transmission source code 40.

The event code 44 is a 3-bit code, for example, and is information indicating the content of an event. Specifically, as examples of the content of an event, “001”, “010”, “011”, “100”, “101”, “110”, and “111” can be set as fire, gas leak, recovery, alarm stop, recovery, inspection, and ACK (acknowledgement), respectively. In addition, if the number of event types is increased, the number of bits of the event code 44 is increased to 4 bits or 5 bits so that the content of an event of the type corresponding to the number of bits can be expressed.

FIG. 4B is an explanatory view showing the format of the relay event signal 46 used in the present embodiment. As shown in FIG. 4B, the relay event signal 46 includes the serial number 38, the transmission source code 40, the group code 42, the event code 44, and a relay destination code 48. The relay event signal 46 is different from the event signal 36 in FIG. 4A only in that the relay destination code 48 is included. Accordingly, detailed explanations regarding the same components as in the event signal 36 will be omitted.

The relay destination code 48 is information for identifying the relay destination. Specifically, a transmission source code of an alarm device designated as a relay destination is stored as the contents of the relay destination code 48.

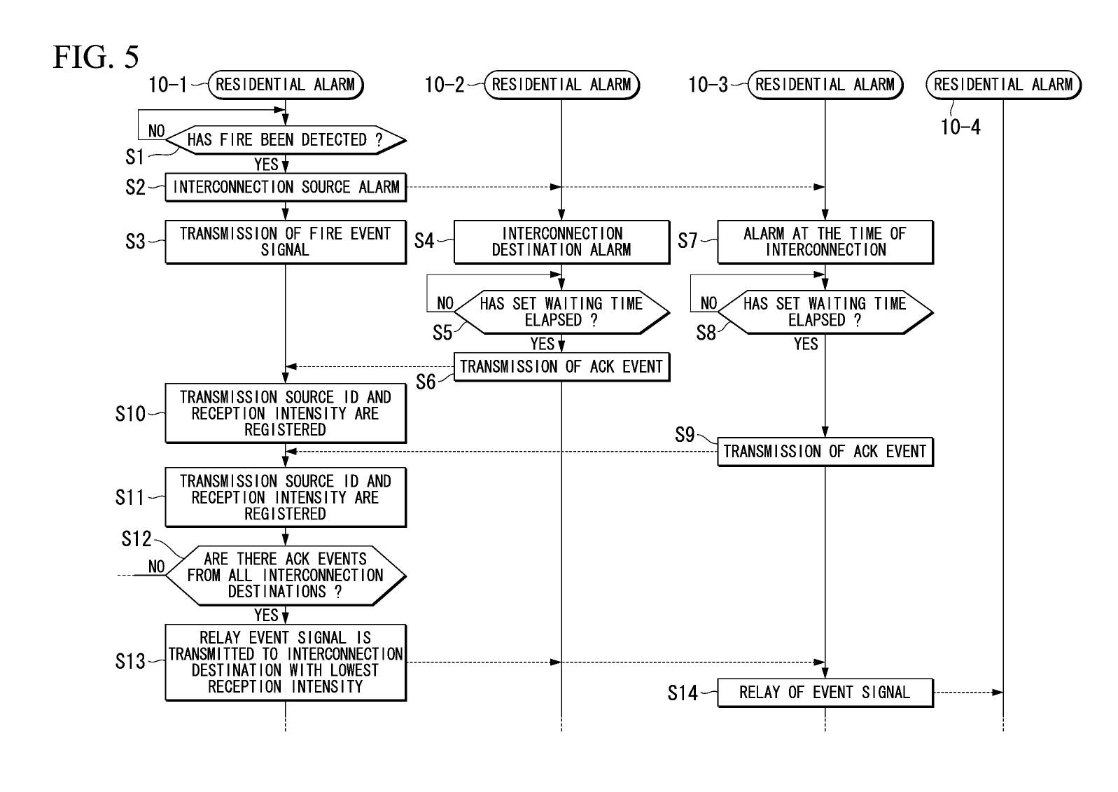

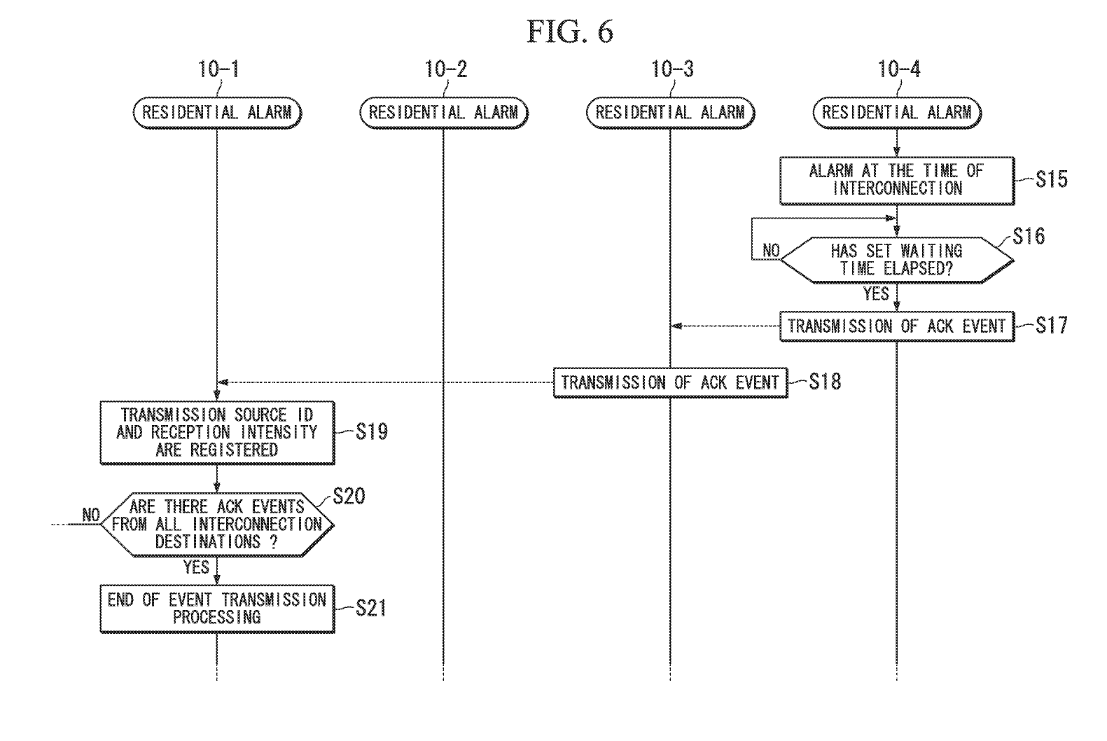

Next, a time chart of event transmission and reception processing in the present embodiment will be described using FIGS. 5 and 6.

First, as shown in FIG. 5, when the alarm device 10-1 detects an abnormality, such as a fire, in process S1, the process proceeds to process S2. In process S2, a warning indicating that the alarm device 10-1 is an alarm device of an interconnection source is output from the alarm device. Then, the process proceeds to process S3. In process S3, a fire event signal indicating an abnormality, such as a fire, is transmitted from the alarm device 10-1 to the alarm devices 10-2 to 10-4 of interconnection destinations.

In process S3, the fire event signal is received by the alarm devices 10-2 and 10-3 but is not received by the alarm device 10-4. Then, the process proceeds to process S4. In process S4, from the alarm device 10-2 which has received the event signal, an interconnection destination warning indicating that the alarm device 10-2 is an alarm device of the interconnection destination is output. Then, the process proceeds to process S5. In process S5, it is determined whether or not a predetermined waiting time has elapsed in the alarm device 10-2. The waiting time described herein is set at random for each alarm device, and has a different length. When it is determined that the predetermined waiting time has elapsed in process S5, the process proceeds to process 6. In process S6, an ACK event signal is transmitted to the alarm device 10-1 of the interconnection source.

Also in the alarm device 10-3, an interconnection destination alarm is output in process S7, it is determined whether or not a predetermined waiting time has elapsed in process S8, and an ACK event signal is transmitted to the alarm device 10-1 of the interconnection source in process S9, in the same manner as in the operations of processes S4 to S6 in the alarm device 10-2.

When the ACK event signal from the alarm device 10-2 is received, the alarm device 10-1 of the interconnection source measures the reception intensity of the ACK event signal. Then, the process proceeds to process S10. In process S10, the reception intensity and a transmission source code indicating that the corresponding signal is a signal transmitted from the alarm device of the interconnection destination are registered in the transmission management table 46 of the memory 22.

In addition, the reception intensity of the ACK event signal transmitted from the alarm device 10-3 is registered in the transmission management table 46 of the memory 22 of the alarm device 10-1 of the interconnection source in process S11, in the same manner as in the operation in process S10.

Then, the process proceeds to process S12. In process S12, it is determined whether or not there have been acknowledgements from the alarm devices of all interconnection destinations with reference to each transmission source code registered in the transmission management table 46 of the alarm device 10-1. Through this determination, the alarm device 10-1 recognizes that an ACK event signal from an alarm device 10-4 has not been received.

Then, the alarm device 10-1 proceeds to process S13. In process S13, the alarm device 10-1 selects the alarm device 10-3, which is a transmission source of the ACK event signal with the lowest reception intensity among the reception intensities of ACK event signals registered in the transmission management table 46, as a relay destination. Then, the alarm device 10-1 designates the alarm device 10-3 as a relay destination to retransmit a relay event signal to the alarm devices 10-2 and 10-3.

The relay event signal retransmitted from the alarm device 10-1 is received by each of the alarm devices 10-2 and 10-3. In this case, since a transmission source code of the alarm device 10-3 is included in the relay event signal, the relay event signal is neglected in the alarm device 10-2 with a different transmission source code. In addition, the relay event signal is recognized in the alarm device 10-3 matching the transmission source code, and the alarm device 10-3 operates as a relay destination. Then, the process proceeds to process S14. In process S14, the relay event signal is converted into a normal event signal in the alarm device 10-3 and is also relay-transmitted from the alarm device 10-3 to the alarm device 10-4.

The event signal relay-transmitted from the alarm device 10-3 is received by the alarm device 10-4. Then, the process in the alarm device 10-4 proceeds to process S15, as shown in FIG. 5. In process S15, a warning indicating that the alarm device 10-4 is an alarm device of the interconnection destination is output. Then, the process proceeds to process S16. In process S16, it is determined whether or not a predetermined waiting time has elapsed. Then, the process proceeds to process S17. In process S17, an ACK event signal indicating the acknowledgement is transmitted to the alarm device 10-1 of the interconnection source.

The ACK event signal transmitted from the alarm device 10-4 to the alarm device 10-1 of the interconnection source is received by the alarm device 10-3 under relay operation. Then, the process proceeds to process S18. In process S18, the ACK event signal is relay-transmitted to the alarm device 10-1 through the alarm device 10-3. After receiving the relay-transmitted ACK event signal, the alarm device 10-1 of the interconnection source proceeds to process S19. In process S19, the reception intensity of the ACK event signal is registered in the transmission management table 46 together with a transmission source code indicating the interconnection destination.

Then, the process proceeds to process S20. In process S20, it is determined whether or not there have been acknowledgements from the alarm devices 10-2 to 10-4 of all interconnection destinations with reference to the transmission management table 46. In this case, when it is determined that there have been acknowledgements from all the alarm devices 10-2 to 10-4, the process proceeds to process S21 to terminate the event signal transmission processing normally.

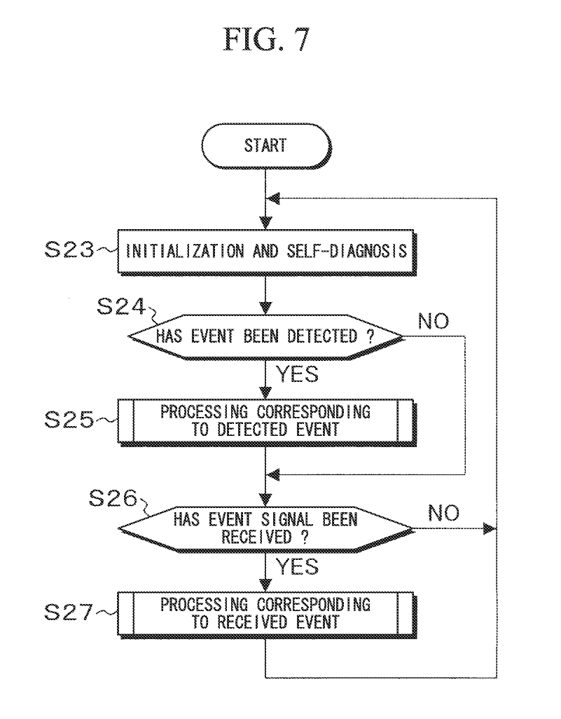

Next, basic processing of an alarm device in the present embodiment will be described using FIG. 7. First, at the start of power supply from the battery power 30 of the alarm device 10-1, the process proceeds to process S23. In process S23, initialization and self-diagnosis of the alarm device 10-1 is executed. When there is no abnormality in the processing of process S23, the process proceeds to process S24. In process S24, the event detecting section 64 checks whether or not an event has been detected. When it is determined that an event has been detected in process S24, the process proceeds to process S25. In process S25, processing corresponding to the detected event is executed.

Then, the process proceeds to process S26. In process S26, it is checked whether or not an event signal from the alarm device of the interconnection destination has been received. When it is determined that an event signal has been received in process S26, the process proceeds to process S27. In process S27, processing corresponding to the received event is executed.

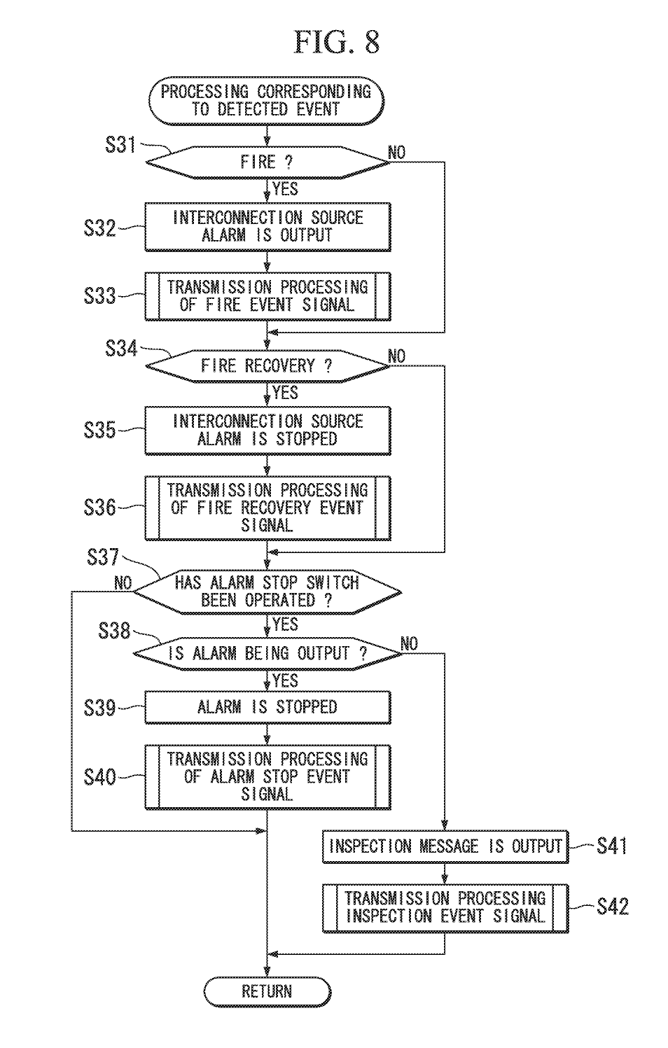

Next, details of the processing corresponding to the detected event in process S25 of FIG. 7 will be described using FIG. 8. The processing corresponding to the detected event in process S25 is executed by a program of the processor 18 shown in FIG. 2.

First, when the event information is transmitted for the processing corresponding to the detected event at the time of processing of process S25 in FIG. 7, the process proceeds to process S31 in FIG. 8. In process S31, it is determined from the event information whether or not an abnormality has occurred. process S31 is a process of monitoring an abnormality, such as a fire, and it is determined that an abnormality, such as a fire, has occurred when the smoke detection signal output from the sensor unit 24 exceeds a predetermined level.

When it is determined that an abnormality has occurred in process S31, the process proceeds to process S32. In process S32, a fire alarm device indicating the interconnection source is output by a warning sound from the speaker 58 and a display based on lighting of the LED 60.

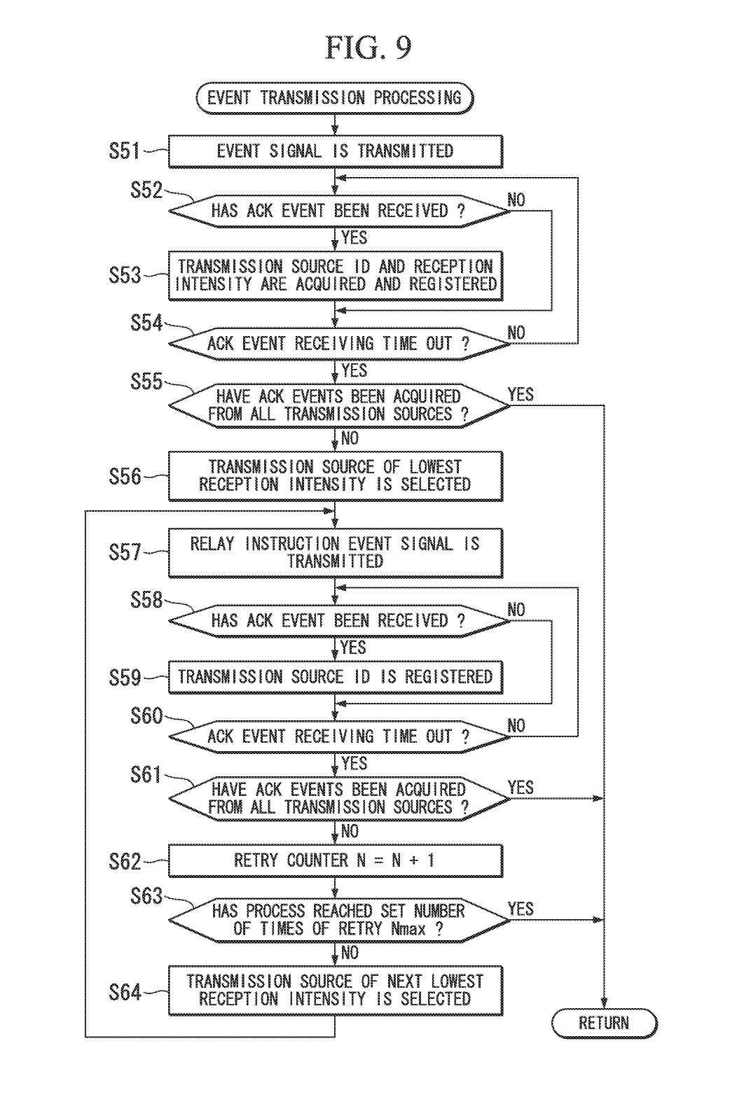

Then, the process proceeds to process S33. In process S33, an event signal, such as a fire event signal, is transmitted to the alarm devices 10-2 to 10-4 of the interconnection destinations. The event signal transmission processing includes receiving an ACK event signal from an alarm device of an interconnection destination and retransmitting a relay event signal when acknowledgements from all interconnection destinations are not received. Details of the event signal transmission processing are shown in FIG. 9.

Then, the process proceeds to process S34. In process S34, the strength of the smoke detection signal from the sensor unit 24 is determined and it is also determined whether or not the fire state has been eliminated. When elimination of the fire state and the fire recovery are determined in process S34, the process proceeds to process S35. In process S35, a fire alarm indicating the interconnection source is stopped. Then, the process proceeds to process S36. In process S36, an event signal including an event code indicating fire recovery is transmitted to the alarm device of the interconnection destination by radio. Details of the event signal transmission processing in this case are shown in FIG. 9.

Then, the process proceeds to process S37. In process S37, it is determined whether or not the alarm stop switch 52 has been operated. When it is determined that there has been a switch operation, the process proceeds to process S38. In process S38, it is determined whether or not an alarm device is being output. When it is determined that an alarm device is being output in process S38, the process proceeds to process S39. In process S39, the alarm device is stopped. Then, the process proceeds to process S40. In process S40, an event signal including an event code of alarm stop is transmitted to the alarm device of the interconnection destination. Details of the event signal transmission processing in this case are shown in FIG. 9.

On the other hand, when it is determined that an alarm is not being output in process S38, the process proceeds to process S41. In process S41, an event signal including an event code indicating an inspection instruction is transmitted to the alarm device of the interconnection destination. Then, the process proceeds to process S42. In process S42, predetermined inspection processing is performed, and an inspection message showing the inspection result is output. Details of the event signal transmission processing in process S41 are shown in FIG. 9.

Next, details of the event signal transmission processing in processes S33, S36, S40, and S41 of FIG. 8, will be described using FIG. 9. First, when the event information is transmitted in the event signal transmission processing in FIG. 8, the process proceeds to process S51 in FIG. 9. In process S51, an event signal is transmitted to the alarm device of the interconnection destination. In this case, an event code, such as a fire, fire recovery, alarm stop, or inspection, is given to the event signal according to the content of the event. Then, the process proceeds to process S52. In process S52, it is determined whether or not an ACK event signal from the alarm device of the interconnection destination has been received.

When it is determined that the ACK event signal has been received in process S52, the process proceeds to process S53. In process S53, the reception intensity acquired from the reception intensity measuring section 35 is registered in the transmission management table 46 together with the transmission source code obtained from the ACK event signal.

Then, the process proceeds to process S54. In process S54, it is monitored whether or not a predetermined ACK receiving time set in advance has elapsed. In this case, the ACK receiving time is set in advance with a length exceeding the longest waiting time set in an alarm device.

When it is determined that the predetermined ACK receiving time has elapsed in process S54, the process proceeds to process S55. In process S55, it is determined whether or not ACK event signals (acknowledgements) have been acquired from alarm devices of all interconnection destinations with reference to the transmission management table 46. In this case, when it is determined that ACK event signals have been acquired from the alarm devices of all interconnection destinations, the transmission processing ends and the process returns to FIG. 8 to continue the processing. On the other hand, if there are one or more alarm devices which have not transmitted an acknowledgement signal to the alarm device 10-1 of the interconnection source among the alarm devices of all interconnection destinations registered in advance, the process proceeds to processing of process S56.

In process S56, a transmission source code of an interconnection destination with the lowest reception intensity of the ACK event signals, which is registered in the transmission management table 46, is selected, and this transmission source code is given to the relay event signal as a relay destination code 48 in FIG. 4B. Then, the process proceeds to process S57. In process S57, the relay event signal is transmitted.

After transmitting the relay event signal, the process proceeds to process S58. In process S58, it is determined whether or not an ACK event signal (acknowledgement) from the alarm device of the interconnection destination has been acquired. When it is determined that the ACK event signal has been received in process S58, the process proceeds to process S59. In process S59, the reception intensity acquired from the reception intensity measuring section 35 is registered in the transmission management table 46 of the memory 22 together with the transmission source code obtained from the ACK event signal.

Then, the process proceeds to process S60. In process S60, it is monitored whether or not a predetermined ACK receiving time set in advance has elapsed. When it is determined that the predetermined ACK receiving time has elapsed in process S60, the process proceeds to process S61. In process S61, it is determined whether or not ACK event signals have been acquired from alarm devices of all interconnection destinations with reference to the transmission management table 46. In this case, when it is determined that ACK event signals have been acquired from the alarm devices of all interconnection destinations, the transmission processing ends.

On the other hand, if there are one or more alarm devices which have not transmitted an ACK event signal to the alarm device 10-1 of the interconnection source among the alarm devices of the interconnection destinations registered in advance, the process proceeds to processing of process S62. In process S62, a retry counter N is counted up by 1. Then, the process proceeds to process S63. In process S63, it is determined whether or not a predetermined number of times of retry have reached N times which is a max. If it reaches N times, the process proceeds to process S64. In process S64, a transmission source code of an interconnection destination with the second lowest reception intensity of the ACK event signals, which is registered in the transmission management table 46, is selected, and the process returns to process S57 to transmit the relay event signal in FIG. 4B.

Such processing in processes S57 to S64 is repeated until acknowledgements of all interconnection destinations are obtained. Then, when the retry counter reaches N times, which is a max, when it becomes retry out, the process ends and returns to the processing in FIG. 8.

In addition, even in the case of retry out without obtaining acknowledgements from alarm devices of all interconnection destinations, this is not determined to be an error. This is because degradation of the radio environment in which an event signal cannot be received is temporary in many cases and accordingly, a possibility that the radio environment will be improved is high when transmitting an event signal again. From this, unnecessary determination as an error does not need to be made.

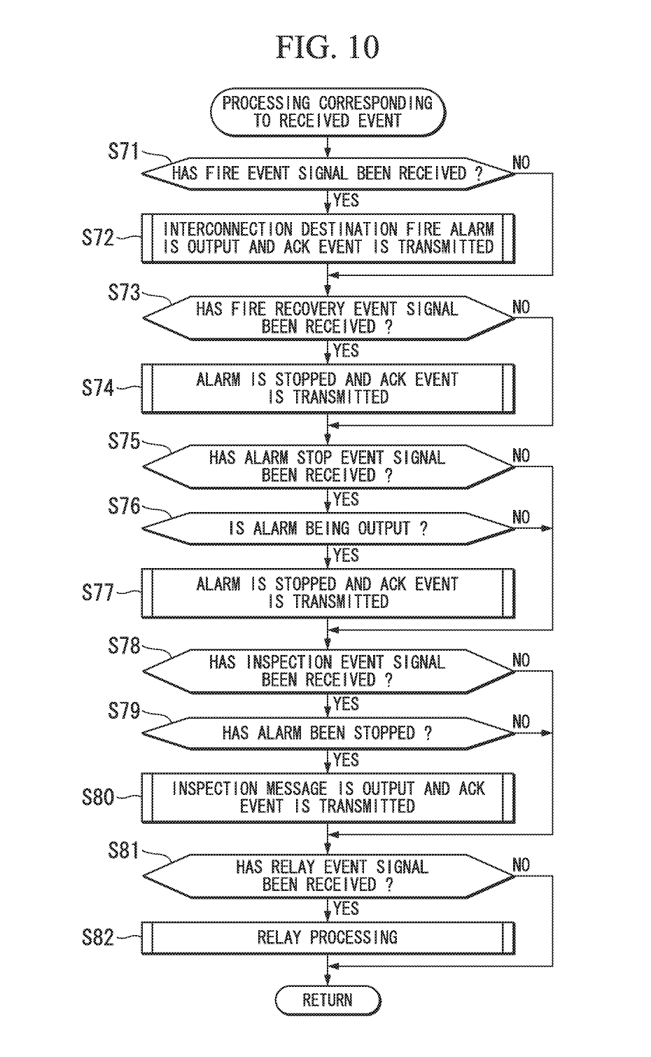

Next, details of the processing corresponding to the received event in process S27 of FIG. 7 will be described using FIG. 10. FIG. 10 is a flow chart showing details of the processing corresponding to the received event in process S27 of FIG. 7, and is executed by a program of the processor 18.

First, when the event information is transmitted to the processing corresponding to the received event in FIG. 7, the process proceeds to process S71 in FIG. 10. In process S71, it is determined whether or not an event signal indicating an abnormality, such as a fire, has been received. In this case, when it is determined that an event signal indicating an abnormality, such as a fire, has been received, the process proceeds to process S72. In process S72, display based on a warning sound from the speaker 48 and flashing of the LED 50 is performed as a fire alarm indicating the interconnection destination. Furthermore, an ACK event signal is transmitted with ACK as an event code for acknowledgement.

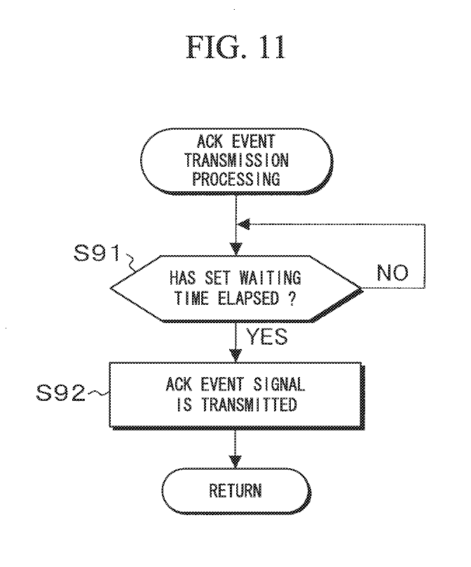

After transmission of ACK transmission processing, it is determined whether or not a waiting time set in advance has elapsed in process S91, as shown in FIG. 11. In this case, when it is determined that the waiting time has elapsed, the process proceeds to process S92. In process S92, an ACK event signal is transmitted. Thus, by transmitting an ACK event signal after a waiting time which differs depending on each alarm device, collisions of ACK event signals due to simultaneous transmission of the ACK event signals can be avoided.

As shown in FIG. 10, after transmitting the ACK event signal in process S72, the process proceeds to process S73. In process S73, it is determined whether or not an event signal of fire recovery has been received. In this case, when it is determined that an event signal indicating fire recovery has been received, the process proceeds to process S74. In process S74, a fire alarm is stopped and ACK transmission processing of transmitting an ACK event signal to the alarm device of the interconnection source for acknowledgement is performed.

Then, the process proceeds to process S75. In process S75, it is determined whether or not an event signal indicating alarm stop has been received. In this case, when it is determined that an event signal indicating alarm stop has been received, the process proceeds to process S76. In process S76, it is determined whether or not an alarm is being output. When it is determined that an alarm is being output in process S76, the process proceeds to process S77. In process S77, a fire alarm is stopped and an ACK event signal is transmitted for acknowledgement.

Then, the process proceeds to process S78. In process S78, it is determined whether or not an event signal indicating that an inspection is being performed has been received. In this case, when it is checked that an event signal indicating that an inspection is being performed has been received, the process proceeds to process S79. In process S79, it is determined whether or not an alarm is stopped. When it is determined that an alarm is stopped, the process proceeds to process S80. In process S80, predetermined inspection processing is performed, and an inspection message showing the result of the inspection processing is output from the speaker 58 of the alarm unit 26 and an ACK event signal is transmitted.

Then, the process proceeds to process S81. In process S81, it is determined whether or not a relay event signal has been received. When it is checked that a relay event signal has been received, the process proceeds to process S82. In process S82, relay processing is executed.

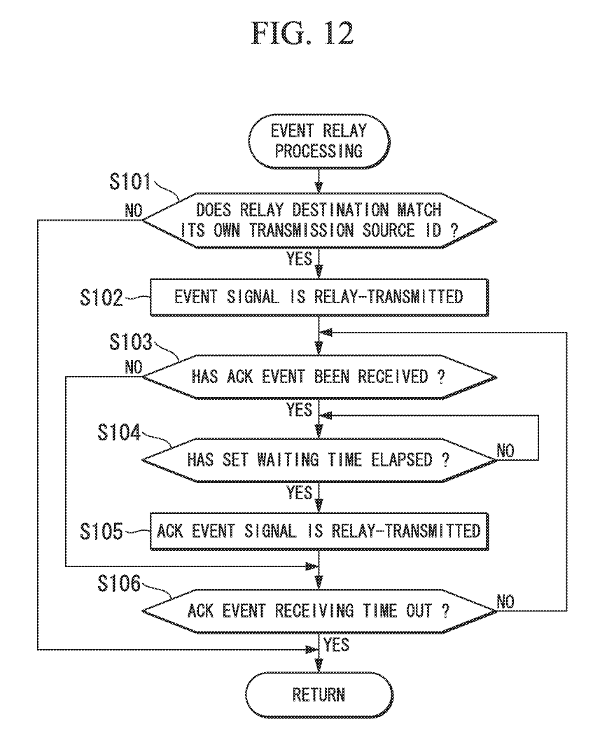

Next, details of the relay processing in process S82 of FIG. 10 will be described using FIG. 12. First, when event relay processing is transmitted in process S82 of FIG. 10, the process proceeds to process S101 in FIG. 12. In process S101, a relay event signal is received. In this case, it is determined whether or not the relay destination code of the relay event signal matches a transmission source code of the alarm device which has performed in process S82. In this case, when it is determined that the relay destination code matches the transmission source code, the alarm device which has performed process S82 is recognized as a relay destination. Then, the process proceeds from process S101 to process S102. In process S102, an event signal from the alarm device 10-1 is relay-transmitted. The event signal is converted into a normal event signal shown in FIG. 4A by removing the relay destination code 48 from the received relay event signal 46 in FIG. 4B at the time of this relay transmission.

Then, the process proceeds to process S103. In process S103, it is determined whether or not an ACK event signal has been transmitted from the alarm device of the interconnection destination on the basis of the relay-transmitted event signal. In this case, when it is determined that the ACK event signal has been received from the alarm device of the interconnection destination, the process proceeds to process S104. In process S104, it is determined whether or not a predetermined waiting time has elapsed. In process S104, when it is determined that a predetermined waiting time has elapsed, the process proceeds to process S105. In process S105, the ACK event signal is relay-transmitted as it is.

Such processing in processes S103 to S105 is repeated until it is determined that the ACK receiving time which is a predetermined time is out in process S 106. Then, when it is determined that the ACK receiving time is out, the event relay processing ends, and the process returns to the processing in FIG. 10.

Here, in process S102, since the event signal transmitted from the relay destination is also received by an alarm device which sent a reception response once, an ACK event signal is also returned from such an alarm device. In addition, the ACK event signal transmitted from the alarm device which sent a reception response once is also relay-transmitted to the interconnection source without any distinction. However, since such an ACK event signal has already been received by the interconnection source, receiving processing as an effective ACK event signal is not performed. Thus, even if an ACK event signal is transmitted from an alarm device which sent a reception response once, it is possible to prevent repeated receiving processing.

In addition, a method of preventing repeated receiving processing of an ACK event signal is not limited only to the above-described method, and it is also possible to adopt a method of performing relay transmission in a state where a relay destination code is left in a relay event signal. In the case of adopting this method, it is preferable to set a receiving side alarm device such that when a received event signal is recognized as a relay event signal, transmission of an unnecessary ACK event signal is not performed if the received event signal is an event signal already received.

In addition, although respective alarm devices communicate with each other without distinction between a base unit/extension unit in the embodiment described above, the above embodiment may also be applied for communication of an event signal from a base unit to an extension unit in an alarm system in which the base unit and the extension unit are distinguished from each other.

In addition, although the alarm device which detects a fire as an abnormality and gives a warning has been described as an example in the above embodiment, the kind of abnormality is not limited to a fire. For example, the above embodiment may also be similarly applied to alarm systems in which a gas leak alarm device, a CO alarm device, and various kinds of security alarm devices are placed.

In addition, the flow chart in the above embodiment is for explaining an example of the outline of processing, and the order of processing and the like are not limited only to the above embodiment. In addition, a delay time may be set or other determination may be inserted during each processing or between processing and processing when necessary.

In addition, the above-described embodiment is not limited only to residences, and may also be applied to alarm devices for various applications, such as office buildings.

In addition, although the case where a sensor unit and an alarm output processing unit are integrally provided in an alarm device is described as an example in the above embodiment, it is also possible to use an alarm device having a sensor unit and an alarm output processing unit as separate units.

In addition, the present invention is not limited only to the above-described embodiment, and includes appropriate modifications without impairing its purpose and advantages. Moreover, the present invention is not restricted by the numeric values shown in the above embodiments.

### Reference Signs List

10-1 to 10-4: alarm device

11, 14: event signal

12, 15, 16: ACK event signal

13: relay event signal

18: CPU

20: radio communication unit

21: antenna

22: memory

24: sensor unit

26: alarm unit

28: operation unit

30: battery power

32: signal transmission circuit

34: signal receiving circuit

36: event signal

38: serial number

40: transmission source code

42: group code

44: event code

46: relay event signal

48: relay destination code

50: set waiting time

52: transmission management table

56: smoke detecting section

58: speaker

60: LED

62: alarm stop switch

64: event detecting section

66: transmission processing section

68: receiving processing section

70: alarm processing section

72: acknowledgement section

74: retransmission processing section

76: relay processing section

1. A relay method for an alarm system comprising:
a first process in which an alarm device that has detected an abnormality, among a plurality of alarm devices arranged in a monitored area and interconnected with each other, outputs an abnormality warning indicating that a sender thereof is a source alarm device, and in which an abnormality signal is transmitted to all of destination alarm devices interconnected with the source alarm device;
a second process in which a destination alarm device that has received the abnormality signal outputs a signal indicating that senders thereof is the destination alarm device, and in which an acknowledgement signal is transmitted to the source alarm device;
a third process in which a reception intensity of the acknowledgement signal is measured when the source alarm device receives the acknowledgement signal, and in which, if there are one or more destination alarm devices that have not transmitted the acknowledgement signal among all of destination alarm devices registered in advance, a destination alarm device that has the lowest reception intensity of the acknowledgement signal is assigned as a relay destination alarm device; and
a fourth process in which an abnormality signal is relay-transmitted from the source alarm device, through the relay destination alarm device, to destination alarm devices that are interconnected with the relay destination alarm device, and then, from a destination alarm device that has received the abnormality signal, a signal is outputted indicating that a sender thereof is a destination alarm device, and also an acknowledgement signal is transmitted to the source alarm device,
wherein when there are one or more destination alarm devices which have not transmitted an acknowledgement signal to the source alarm device among all of destination alarm devices registered in advance, the third and fourth processes are repeated.

2. The relay method for the alarm system according to claim 1,
wherein the third and fourth processes are repeated a predetermined number of times until the source alarm device receives acknowledgement signals from the all of the destination alarm devices registered in advance.

3. An alarm device comprising:
a sensor unit that detects a physical phenomenon in a surveyed area and outputs the physical phenomenon;
a radio communication unit that transmits and receives a signal by radio to and from a destination alarm device that is a communication target of the radio communication unit;
an alarm unit that outputs an abnormality warning;
an event detection unit that detects an event including existence or non-existence of an abnormality, through a detection output of the sensor unit;
a transmission processing unit that transmits an event signal representing the event to the destination alarm device that is the communication target of the radio communication unit;
a receiving processing unit that receives the event signal from the destination alarm device that is the communication target of the radio communication unit;
an alarm processing unit that, when the event detection unit detects the abnormality, cause the alarm unit to output an abnormality warning indicating that the alarm device is a source alarm device, and also cause the alarm unit to transmit an event signal indicating an abnormality to the destination alarm device that is the communication target of the radio communication unit, and that, when the destination alarm device receives the event signal indicating an abnormality from the source alarm device, cause the alarm unit to output an abnormality warning indicating that the alarm device is a destination alarm device;
an acknowledgement unit that transmits an acknowledgement signal when the destination alarm device receives the event signal from the source alarm device;
a retransmission processing unit that, when the acknowledgement signal is received from the destination alarm device, measures a reception intensity and registers the reception intensity together with information regarding the destination alarm device, and that, when there are one or more destination alarm devices which have not transmitted an acknowledgement signal among all of destination alarm devices registered in advance, repeats processing in which the destination alarm devices are designated as a relay destination alarm device in a low-to-high order of the acknowledgement signal reception intensity, and an event signal is transmitted; and
a relay processing unit that, when an event signal or an acknowledgement signal designating the alarm device as the relay destination alarm device is received, relay-transmits the received event signal or the received acknowledgement signal to the destination alarm device.

4. The alarm device according to claim 3,
wherein when the retransmission processing unit repeats a processing in which the destination alarm devices are designated as the relay destination alarm devices and the event signal is transmitted in a low-to-high order of the acknowledgement signal reception intensity, the processing is repeated for a predetermined number of times, until acknowledgement signals from all of the destination alarm devices registered in advance are received.
